(19) United States
(12) Patent Application Publication
(10) Pub. No.: US 2024/0205011 A1
(43) Pub. Date: Jun. 20, 2024

(54) ZERO KNOWLEDGE PROOF OF SMART CONTRACT COMPUTATION USING PRIVATE INPUT

(71) Applicant: Telefonaktiebolaget LM Ericsson (publ), Stockholm (SE)

(72) Inventor: Rémi ROBERT, SOLNA (SE)

(73) Assignee: Telefonaktiebolaget LM Ericsson (publ), Stockholm (SE)

(21) Appl. No.: 18/557,502

(22) PCT Filed: May 4, 2021
(86) PCT No.: PCT/IB2021/053758

§ 371 Date: Oct. 26, 2023

(51) Int. Cl. H04L 9/32

(52) U.S. Cl. CPC H04L 9/3221; H04L 9/3236

(57) ABSTRACT

A method by a network device implementing a first peer of a distributed ledger to provide trusted execution of a smart contract that uses private data accessible to a second peer of the distributed ledger but not accessible to the first peer. The method includes detecting, during execution of the smart contract, a subroutine of the smart contract that uses the private data, providing an identifier of the subroutine and a proving key to the second peer, obtaining a zero-knowledge proof of computation of the subroutine and a public input to a program adapted for a zero-knowledge proving scheme, wherein the zero-knowledge proof was generated by the second peer, and determining whether the zero-knowledge proof is valid using the zero-knowledge proving scheme based on the public input and a verification key.

### TECHNICAL FIELD

Embodiments of the invention relate to the field of providing trusted execution of smart contracts that use private data.

### BACKGROUND

A blockchain is a type of distributed ledger that has a growing list of records, called blocks, that are linked using cryptography. Each block contains a cryptographic hash of the previous block, a timestamp, and transaction data. By design, a blockchain is resistant to modification of its data. This is because once recorded, the data in any given block cannot be altered retroactively without alteration of all subsequent blocks.

It has been recognized that public blockchains are not suitable for all use cases. One reason for this is that their resilience to modification comes at a considerable performance cost Private blockchains have been developed for use cases with interactions between a limited number of participants that know each other. The main difference between private blockchains and public blockchains is that access to private blockchains is limited to a set of well-known entities.

In a private blockchain, consensus may be achieved even when not all participants are involved in a transaction (so called private transaction). In addition, for this class of blockchain, features allowing to expose data to only a subset of the participants have been developed. It is possible to disclose private transaction data to only some of the peers in the network. This can be achieved as follows: instead of broadcasting the transaction data to all peers, the data is only sent to a subset of peers that will be tasked with executing the transaction. Moreover, the transaction data is not stored in the blockchain, but instead only its hash is recorded therein—the actual data is stored by a transaction manager/database alongside each peer. In the end, all peers maintain one distributed ledger and database: the distributed ledger stores the public state of the blockchain (shared by all the peers) and the database stores the state originating from private transactions that they were granted access to (sometimes called the side database or private database).

For this private data, the notion of an owner can be defined. An owner may be a blockchain participant (a peer or an organization depending on the distributed ledger technology) that is allowed to access, process, and store this private data. As a result, only the owners are able to execute/endorse transactions that affect (e.g., read/write) this private data.

A smart contract is a computer program or a transaction protocol which is intended to automatically execute, control, and/or document relevant events and actions according to the terms of a contract or an agreement. The code and the agreements contained therein may be stored in a blockchain. Smart contracts may provide a basis for trusted computing.

In addition to smart contracts, another way to obtain trusted computing is through verifiable computation With verifiable computation, a mathematical proof is provided with the computation result (computed by the prover) and allows the receiver (the verifier) to verify that the computation was performed correctly. Such a proof can be non-interactive, meaning that it does not require any interaction between the prover and the verifier beyond transmission of the proof and the result. Furthermore, such a proof can also be qualified as “zero-knowledge” if it does not reveal anything beyond the validity of the result (the value of the result and of any intermediary steps are not disclosed). An example of a non-interactive zero-knowledge proving scheme is zero-knowledge succinct non-interactive argument of knowledge (ZK-SNARK).

### SUMMARY

A method by a network device implementing a first peer of a distributed ledger to provide trusted execution of a smart contract that uses private data accessible to a second peer of the distributed ledger but not accessible to the first peer. The method includes receiving a request to execute the smart contract, beginning execution of the smart contract, detecting, during the execution of the smart contract, a subroutine of the smart contract that uses the private data, generating a program adapted for a zero-knowledge proving scheme based on the subroutine, wherein the program adapted for the zero-knowledge proving scheme includes logic to verify that the private data corresponds to manipulation detection codes of the private data, generating a proving key and a verification key based on the program adapted for the zero-knowledge proving scheme, generating a partial execution result of the smart contract, providing an identifier of the subroutine and the proving key to the second peer, obtaining a zero-knowledge proof of computation of the subroutine and a public input to the program adapted for the zero-knowledge proving scheme, wherein the zero-knowledge proof was generated by the second peer based on the proving key, determining whether the zero-knowledge proof is valid using the zero-knowledge proving scheme based on the public input and the verification key, determining whether the public input is valid, restoring an execution state of the smart contract using the partial execution result in response to a determination that the zero-knowledge proof and the public input are valid, applying effects of the subroutine, resuming the execution of the smart contract after the subroutine to generate a full execution result of the smart contract, and providing the full execution result to a consensus mechanism of the distributed ledger.

A method by a network device implementing a second peer of a distributed ledger to provide trusted execution of a smart contract that uses private data accessible to the second peer but not accessible to a first peer of the distributed ledger. The method includes receiving a request to execute the smart contract, a proving key, and an identifier of a subroutine of the smart contract for which proof of computation is requested, wherein the subroutine uses the private data, beginning execution of the smart contract, detecting, during the execution of the smart contract, the subroutine, generating a program adapted for a zero-knowledge proving scheme based on the subroutine, wherein the program adapted for the zero-knowledge proving scheme includes logic to verify that the private data corresponds to manipulation detection codes of the private data, executing the subroutine, generating a zero-knowledge proof of computation of the subroutine using the zero-knowledge proving scheme based on the program adapted for the zero-knowledge proving scheme, a public input to the program adapted for the zero-knowledge proving scheme, a private input to the program adapted for the zero-knowledge proving scheme, and the proving key, resuming the execution of the smart contract after the subroutine to generate a full execution result of the smart contract, providing, to the first peer, the zero-knowledge proof and the public input, and providing the full execution result to a consensus mechanism of the distributed ledger.

A set of non-transitory machine-readable media having computer code stored therein, which when executed by a set of one or more processors of a network device implementing a first peer of a distributed ledger, causes the first peer to perform operations for providing trusted execution of a smart contract that uses private data accessible to a second peer of the distributed ledger but not accessible to the first peer. The operations include receiving a request to execute the smart contract, beginning execution of the smart contract, detecting, during the execution of the smart contract, a subroutine of the smart contract that uses the private data, generating a program adapted for a zero-knowledge proving scheme based on the subroutine, wherein the program adapted for the zero-knowledge proving scheme includes logic to verify that the private data corresponds to manipulation detection codes of the private data, generating a proving key and a verification key based on the program adapted for the zero-knowledge proving scheme, generating a partial execution result of the smart contract, providing an identifier of the subroutine and the proving key to the second peer, obtaining a zero-knowledge proof of computation of the subroutine and a public input to the program adapted for the zero-knowledge proving scheme, wherein the zero-knowledge proof was generated by the second peer based on the proving key, determining whether the zero-knowledge proof is valid using the zero-knowledge proving scheme based on the public input and the verification key, determining whether the public input is valid, restoring an execution state of the smart contract using the partial execution result in response to a determination that the zero-knowledge proof and the public input are valid, applying effects of the subroutine, resuming the execution of the smart contract after the subroutine to generate a full execution result of the smart contract, and providing the full execution result to a consensus mechanism of the distributed ledger.

A set of non-transitory machine-readable media having computer code stored therein, which when executed by a set of one or more processors of a network device implementing a second peer of a distributed ledger, causes the second peer to perform operations for providing trusted execution of a smart contract that uses private data accessible to the second peer but not accessible to a first peer of the distributed ledger. The operations include receiving a request to execute the smart contract, a proving key, and an identifier of a subroutine of the smart contract for which proof of computation is requested, wherein the subroutine uses the private data, beginning execution of the smart contract, detecting, during the execution of the smart contract, the subroutine, generating a program adapted for a zero-knowledge proving scheme based on the subroutine, wherein the program adapted for the zero-knowledge proving scheme includes logic to verify that the private data corresponds to manipulation detection codes of the private data, executing the subroutine, generating a zero-knowledge proof of computation of the subroutine using the zero-knowledge proving scheme based on the program adapted for the zero-knowledge proving scheme, a public input to the program adapted for the zero-knowledge proving scheme, a private input to the program adapted for the zero-knowledge proving scheme, and the proving key, resuming the execution of the smart contract after the subroutine to generate a full execution result of the smart contract, providing, to the first peer, the zero-knowledge proof and the public input, and providing the full execution result to a consensus mechanism of the distributed ledger.

### BRIEF DESCRIPTION OF THE DRAWINGS

The invention may best be understood by referring to the following description and accompanying drawings that are used to illustrate embodiments of the invention. In the drawings:

FIG. 1 is a block diagram of a system that provides trusted execution of a smart contract that uses private data, according to some embodiments.

FIG. 2 is a diagram illustrating interactions between the components of the system to provide trusted execution of a smart contract that uses private data, according to some embodiments.

FIG. 3 is a diagram illustrating operations of “Smart Contract Execution A Part 1,” according to some embodiments.

FIG. 4 is a diagram illustrating operations of “Smart Contract Execution B,” according to some embodiments.

FIG. 5 is a diagram illustrating operations of “Smart Contract Execution A Part 2,” according to some embodiments.

FIG. 6 is a flow diagram of a process (implemented by a first peer of a distributed ledger) for providing trusted execution of a smart contract that uses private data, according to some embodiments.

FIG. 7 is a flow diagram of a process (implemented by a second peer of a distributed ledger) for providing trusted execution of a smart contract that uses private data, according to some embodiments.

FIG. 8 is a flow diagram of a process (implemented by a client component) for providing trusted execution of a smart contract that uses private data, according to some embodiments.

FIG. 9A illustrates connectivity between network devices (NDs) within an exemplary network, as well as three exemplary implementations of the NDs, according to some embodiments.

FIG. 9B illustrates an exemplary way to implement a special-purpose network device according to some embodiments.

### DETAILED DESCRIPTION

The following description describes methods and apparatus for providing trusted execution of a smart contract that uses private data. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

A drawback of existing smart contract execution techniques is that it is not possible to keep data strictly private while also providing a guarantee that a smart contract modifying this private data has been properly executed. If the private data is not disclosed, it is still possible to execute the smart contract. However, only the data owner can execute and vouch for the correctness of the execution. Other members of the distributed ledger will only be able to see that the data is not modified in between executions of the smart contract, and not that the data is properly modified by the smart contract.

The naïve solution to this problem is to disclose the private data to other parties to allow them to also verify/endorse the execution of the smart contract. While this solves the problem, it weakens the privacy guarantees since the private data needs to be shared with other parties. The number of parties that need to endorse the transaction (and thus have access to the private data) is dependent on the business application. In the worst-case scenario it could require all members of the distributed ledger to have access to the private data, which is clearly undesirable from a privacy perspective.

For example, in the context of a smart contract implementing a marketplace, each service provider may have a reputation score that should be kept as private as possible. This reputation score starts at 100 when the account is created and decreases if the service provider misbehaves. Also, the service provider is required to disclose when its reputation score reaches zero. With existing smart contract execution techniques, if the service provider is the only one that can access this data, it can be guaranteed that the reputation score is only modified when a given smart contract is executed. However, there is no guarantee that the service provider is properly applying the required modification or discloses that its reputation score reached zero.

Embodiments disclosed herein provide trusted execution of a smart contract that uses private data. According to some embodiments, when a first peer of a distributed ledger executes a smart contract and encounters a subroutine of the smart contract that uses private data that it does not have access to, the first peer generates a program adapted for a zero-knowledge proving scheme (e.g., an arithmetic circuit if the zero-knowledge proving scheme being used is zero-knowledge succinct non-interactive argument of knowledge (ZK-SNARK)) that includes logic to perform the same task as the subroutine but also to verify that the private data used in the subroutine corresponds to manipulation detection codes of the private data (e.g., hashes of the private data) stored in the public part of the distributed ledger. The program adapted for the zero-knowledge proving scheme may be engineered to have a public input and a private input. The public input may include values of inputs to the subroutine, public data used in the subroutine, the manipulation detection codes of the private data, and an output of the subroutine. The private input may include the private data. The first peer may also generate a proving key and a verification key based on the program adapted for the zero-knowledge proving scheme. The first peer may suspend execution of the smart contract and save a partial execution result of the smart contract (e.g., an execution state of the smart contract up until the subroutine was encountered). The first peer may then send an identifier of the subroutine and the proving key to a client component.

The client component may identify a second peer of the distributed ledger that has access to the private data. The client component may then send a request to execute the smart contract, the identifier of the subroutine, and the proving key to the second peer. The second peer may execute the smart contract normally to generate a full execution result of the smart contract, and in addition generate a zero-knowledge proof of computation of the subroutine based on the program adapted for the zero-knowledge proving scheme, the public input, the private input, and the proving key. The second peer may then send the zero-knowledge proof and the public input to the client. The client may in turn send the zero-knowledge proof and the public input to the first peer.

The first peer may determine whether the zero-knowledge proof and the public input are valid. If so, the first peer restores the previous execution state of the smart contract using the partial execution result (that the first peer previously saved) and applies the effects of the subroutine (e.g., using information included in the public input). The first peer may then resume execution of the remainder of the smart contract to generate a full execution result of the smart contract. The first peer may send the full execution result to the client component. The client component may send the full execution results generated by the first peer and the second peer to a consensus mechanism of the distributed ledger for endorsement.

The zero-knowledge proof may provide proof that the private data that was read and/or written during execution of the subroutine matches with the data stored in the public part of the distributed ledger. It may also provide proof that the effects of the subroutine are properly derived from the private data and the smart contract logic.

An advantage of embodiments disclosed herein is that they make it possible to trust that the smart contract was properly executed even when the smart contract uses private data that is owned by a single entity. This allows entities to limit the amount of private data that gets exposed as part of smart contract execution. Also, embodiments disclosed herein provide such advantage with limited modifications to the validation procedure of existing smart contract execution techniques. Moreover, embodiments disclosed herein may limit the amount of code that is proven using a zero-knowledge proving scheme (e.g., to just the subroutine that uses private data), which is beneficial since computations involving zero-knowledge proving schemes can become computationally expensive. Embodiments are now described with reference to the accompanying figures.

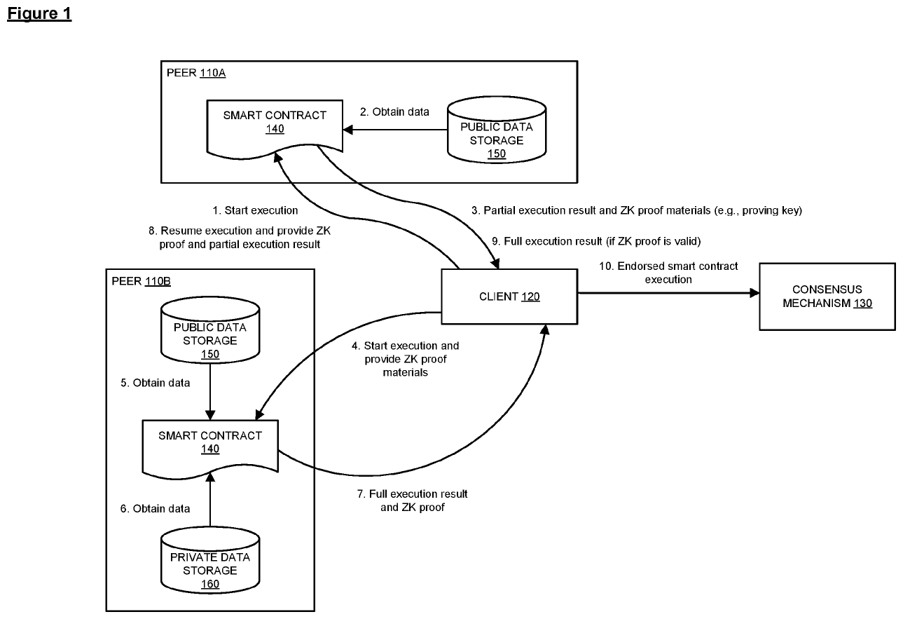

FIG. 1 is a block diagram of a system that provides trusted execution of a smart contract that uses private data, according to some embodiments. As shown in the diagram, the system includes peers 110A and 110B that are members of a distributed ledger, client component 120, and a consensus mechanism for the distributed ledger.

As used herein, a peer (e.g., peer 110A and peer 110B) is a component that is a member of a distributed ledger. Peers 110 may be responsible for storing public data of the distributed ledger, private data, and smart contracts. Also, peers 110 may be responsible for executing and validating transactions, as well as handling transaction requests from client components (e.g., client component 120). The diagram shows two peers 110, namely peer 110A and peer 110B, which may belong to two different organizations (e.g., peer 110A is owned, operated, or otherwise controlled by organization A and peer 110B is owned operated, or otherwise controlled by organization B). As shown in the diagram, both peers 110A and 110B may execute the same smart contract 140 but may differ in the data they have access to. For example, while peer 110A and 110B may both have access to public data storage 150, only peer 110B may have access to private data storage 160 (e.g., which may include data owned by organization B).

The client component 120 is a component that allows an end user to interface with the distributed ledger (e.g., via an application programming interface (API) provided by the peers 110). The client component 120 may generate a request to execute a transaction (e.g., a request to execute a smart contract 140) and send it to one or more peers 110. The client component 120 may send the execution result to a consensus mechanism 130 of the distributed ledger for inclusion in the distributed ledger.

The consensus mechanism 130 is a component that handles the submission of transactions for inclusion in the distributed ledger (after a consensus has been reached). In one embodiment, the consensus mechanism 130 is an orderer node (e.g., in Hyperledger Fabric terminology).

For sake of illustration and ease of explanation, the system is shown as only including two peers 110 and a single client component 120. It should be understood that the system may include more than two peers 110 and more than one client component 120.

An overview of example operations for providing trusted execution of a smart contract will now be described with reference to the block diagram. At operation 1, the client component 120 sends a request to peer 110A to execute the smart contract 140. At operation 2, peer 110A begins execution of the smart contract 140 and in the process obtains data from public data storage 150 that is needed for the execution of the smart contract 140. Peer 110A executes the smart contract 140 up until the point it encounters a subroutine that uses private data that it does not have access to (e.g., private data stored in private data storage 160 of peer 110B). At this point in execution, peer 110A suspends the execution of the smart contract 140 and generates a partial execution result of the smart contract 140. Peer 110A also generates materials for generating a zero-knowledge proof of computation of the subroutine. In one embodiment, the ZK proof materials include a proving key. At operation 3, peer 110A sends the partial execution result and the materials for generating a zero-knowledge proof (referred to in the diagram as “ZK proof materials”) to the client component 120.

At operation 4, the client component 120 sends a request to peer 110B to execute the smart contract 140 and an indication that proof of computation of the subroutine is requested. The client component 120 also sends the ZK proof materials to peer 110B. At operation 5, peer 110B begins execution of the smart contract and in the process obtains public data from public data storage 150 that is needed for execution of the smart contract 140, and at operation 6, obtains the private data from private data storage 160. Peer 110B generates a zero-knowledge proof of computation of the subroutine based on the ZK proof materials, a public input, and a private input (the public/private inputs may be inputs to a program adapted for a zero-knowledge proving scheme (e.g., an arithmetic circuit), and are described in further detail herein). At operation 7, peer 110B sends a full execution result of the smart contract 140 and the zero-knowledge proof and the public input to the client component 120. At operation 8, the client component 120 sends a request to peer 110A to resume execution of the smart contract 140. The client component 120 also sends the zero-knowledge proof (generated by peer 110B), the public input, and the partial execution result to peer 110A. If peer 110A determines that the zero-knowledge proof and the public input are valid, it restores the execution state of the smart contract using the partial execution result, applies effects of the subroutine, and resumes execution of the remainder of the smart contract 140 to generate a full execution result of the smart contract. At operation 9, peer 110A sends the full execution result of the smart contract to the client component 120. At operation 10, the client component 120 sends the full execution results received from peers 110A and 110B to the consensus mechanism 130 for inclusion in the distributed ledger.

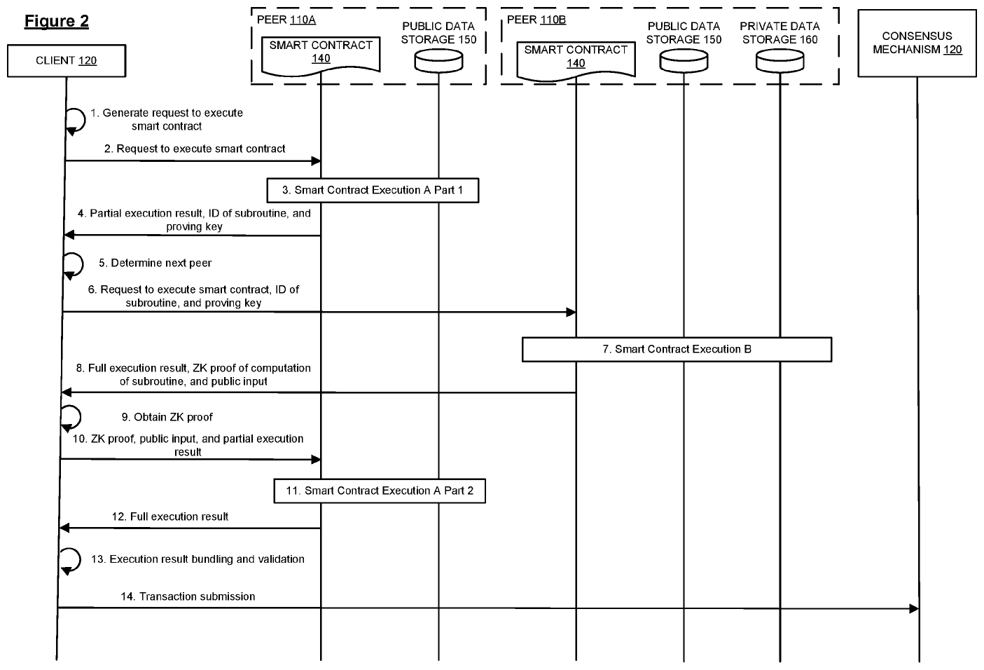

FIG. 2 is a diagram illustrating interactions between the components of the system to provide trusted execution of a smart contract that uses private data, according to some embodiments.

At operation 1, the client component 120 generates a request to execute the smart contract 140. The request may include information about the smart contract, the arguments to use, and/or information about the transaction author. At operation 2, the client component 120 sends the request to execute the smart contract 140 to peer 110A.

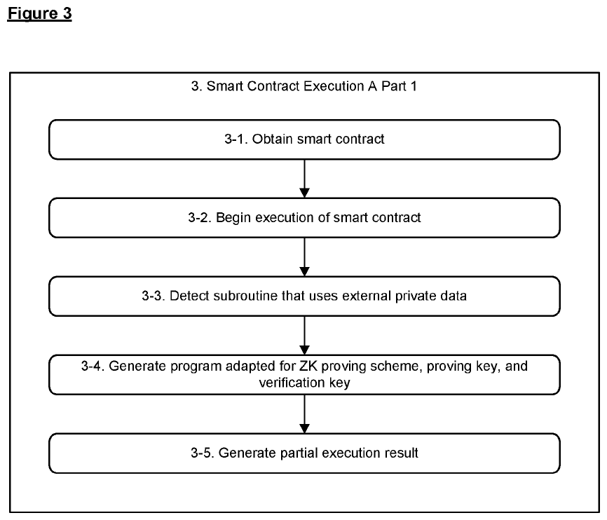

At operation 3, peer 110A performs “Smart Contract Execution A Part 1,” which involves generating a program adapted for a zero-knowledge proving scheme (e.g., an arithmetic circuit), a proving key, a verification key, and a partial execution result of the smart contract up until a subroutine that uses private data was encountered. In one embodiment, the zero-knowledge proving scheme is ZK-SNARK. The proving key may be used by another peer to generate a proof that it executed the smart contract 140 (or at least a portion of it) properly. Operation 3 is described in more detail below with reference to FIG. 3.

At operation 4, peer 110A sends the partial execution result, an identifier of the subroutine, and the proving key to the client component 120. In one embodiment, the partial execution result includes a verification key (e.g., the verification key generated by peer 110A at operation 3). At operation 5, the client component 120 determines the next peer that is to execute the smart contract 140 (the peer that has access to the private data that is used in the subroutine), which in this example is peer 110B. In one embodiment, the client component 120 determines the next peer based on knowledge that the client component 120 has about the distributed ledger network topology. It could also determine the next peer based on information that peer 110A includes in the partial execution result. At operation 6, the client component 120 sends a request to execute the smart contract 140 to peer 110B along with the ID of the subroutine (which indicates that proof of computation is being requested for this subroutine), and the proving key.

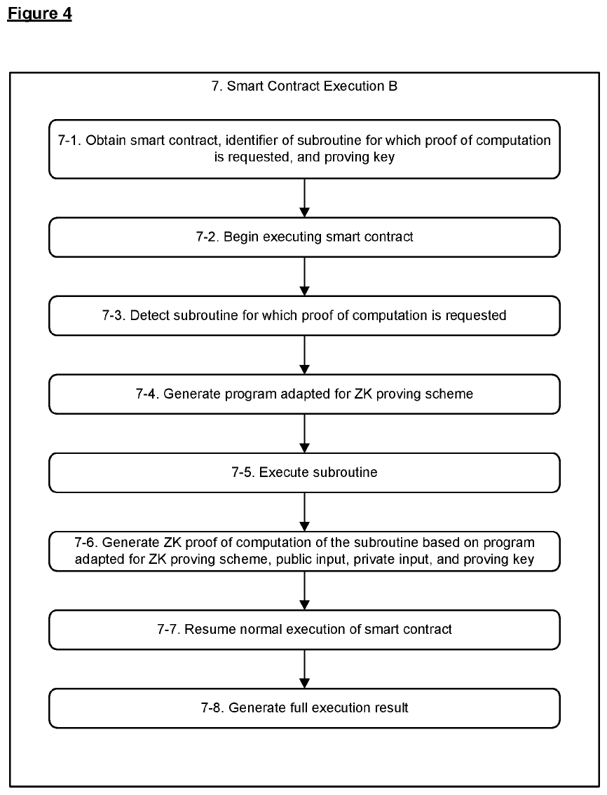

At operation 7, peer 110B performs “Smart Contract Execution B,” which involves generating a zero-knowledge proof of computation of the subroutine, a public input, and a full execution result of the smart contract 140. This operation is described in more detail below with reference to FIG. 4.

At operation 8, peer 110B sends the full execution result, the zero-knowledge proof, and the public input to the client component 120. At operation 9, the client component 120 obtains the zero-knowledge proof (received from peer 110B at operation 8). At operation 10, the client component 120 sends the zero-knowledge proof, the public input, and the partial execution result (received from peer 110A at operation 4, which may include the verification key) to peer 110A. In one embodiment, the client component 120 determines whether the zero-knowledge proof is valid before sending the zero-knowledge proof to peer 110A (and only sends it if it determines that the zero-knowledge proof is valid). In one embodiment, instead of peer 111A sending the partial execution result to the client component 120 (at operation 4) and the client component 120 sending the partial execution result back to peer 110A (at operation 10), peer 110A saves the partial execution result locally and sends an ID associated with the partial execution result (e.g., the ID of the smart contract execution request) to the client component 120. The client component 120 may then send the ID to peer 110A to allow peer 110A to recover the partial execution result.

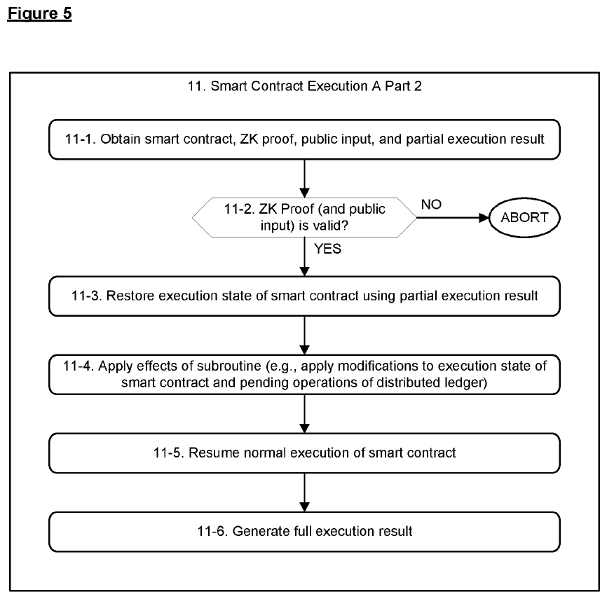

At operation 11, peer 110A performs “Smart Contract Execution A Part 2,” which involves generating a full execution result if it determines that the zero-knowledge proof (and the public input) is valid. This operation is described in more detail below with reference to FIG. 5.

At operation 12, peer 110A sends the full execution result to the client component 120. At operation 13, the client component 120 bundles the full execution results received from peer 110A and peer 110B. This may involve concatenating the full execution results, generating information indicating that the full execution results are associated with each other, and/or use of a compression scheme (as there may be some redundancy in the full execution results). In one embodiment, the client component 120 verifies whether the execution results are identical. If they are not identical, the client component 120 may abort or restart the smart contract execution. At operation 14, the client component 120 sends the bundled full execution results to the consensus mechanism 130 of the distributed ledger for inclusion in the distributed ledger.

While the operations described above involve peer 110A and peer 110B interacting via a client component 120, in other embodiments, peer 110A and peer 110B may interact with each other directly or via a different component.

FIG. 3 is a diagram illustrating operations of “Smart Contract Execution A Part 1,” according to some embodiments. The process may be implemented by peer 110A.

At operation 3-1, peer 110A obtains the smart contract 140. At operation 3-2, peer 110A begins execution of the smart contract 140. This may involve accessing public data stored in the distributed ledger. At operation 3-3, peer 110A detects a subroutine of the smart contract that uses external private data (e.g., private data that it does not have access to such as private data owned by peer 110B). In one embodiment, peer 110A detects the subroutine (where does it start and end) based on analyzing the smart contract 140 itself or based on metadata that was inserted into the smart contract 140 (or otherwise associated with the smart contract 140) indicating that the subroutine uses private data owned by another peer 110. At operation 3-4, peer 110A generates a program adapted for the zero-knowledge proving scheme based on the subroutine, a proving key, and a verification key. In one embodiment, the smart contract 140 includes information to help with generating the program adapted for the zero-knowledge proving scheme, the proving key, the verification key, and/or other materials that are needed for verifying/generating a zero-knowledge proof of computation of the subroutine. At operation 3-5, peer 110A generates a partial execution result (e.g., an execution result up until execution reached the subroutine). In one embodiment, the partial execution result includes a snapshot of a state of a virtual machine (VM) executing the smart contract.

The program adapted for the zero-knowledge proving scheme may be engineered to have a public input and a private input. The public input may include values of inputs to the subroutine, public data used in the subroutine, the manipulation detection codes of the private data, and an output of the subroutine. The private input may include the private data used in the subroutine.

The program adapted for the zero-knowledge proving scheme may include logic to verify or perform the following: (1) for any variable set before the subroutine, obtain their values from the input of the program; (2) for any output of the subroutine (e.g., variable assignments that are made in the subroutine that are used in portions of the smart contract following the subroutine), compare it to the input of the program; (3) for any public writes, check that the keys and values match the input of the program; (4) for any public reads, check that the keys match the input of the program and obtain the corresponding values from the input of the program; (5) for any private writes, check that the manipulation detection codes (e.g., hashes) of the keys and values match the public input of the program; and (6) for any private reads, check that the manipulation detection codes of the keys match the public input of the program and that the manipulation detection codes of the values included in the public input of the program corresponds to the values included in the private input of the program.

In one embodiment, the above logic is described in pseudocode as follows:

```
Write_proven(key_a, val_a):
  Assert(key_a == input_key_a)
  Assert(val_a == input_val_a)
Read_proven(key_a):
  Assert(key_a == input_key_a)
  Return input_val_a
Private_write_proven(key_a, val_a):
  Assert(hash(key_a) == input_key_a)
  Assert(hash(val_a) == input_val_a)
Private_read_proven(key_a):
  Assert(hash(key_a) == input_key_a)
  Assert (hash(private_input_val_a) == input_val_a))
  Return private_input_val_a
Set_variable(var_name, var_value):
  Assert(var_name == input_var_name)
  Assert(var_value == input_var_value)
```

Peer 110A, may maintain a mapping of the inputs of the program to corresponding “variables” in the smart contract.

As an example, assume that the pseudocode of the smart contract is as follows:

| | |
|---|---|
| 1. | let org_name = transaction_input_org_name |
| 2. | |
| 3. | // Start of private subroutine |
| 4. | |
| 5. | let key = org_name + “_reputation” |
| 6. | let reputation = private_read(key) |
| 7. | let new_reputation = reputation + 1 |
| 8. | private_write(key, new_reputation) |
| 9. | let trigger_event = new_reputation < 10 |
| 10. | |
| 11. | // End of private subroutine |
| 12. | |
| 13. | if trigger_event then send_event(BAD_REPUTATION, org_name) |

The pseudocode for the program adapted for the zero-knowledge proving scheme may be as follows:

let key = org_name + “_reputation”
// Read
Assert(hash(pvt_key) == hash_key))
Assert(hash(prv_key_value) == hash_key_value))
let reputation = prv_key_value
let new_reputation = reputation + 1
// Write
Assert(hash(pvt_key) == hash_key)
Assert(hash(pvt_new_reputation) == hash_new_reputation)
let trigger_event = new_reputation < 10
Assert(“trigger_event” == output_1_name)
Assert(trigger_event == output_1_value)

The inputs of the program adapted for the zero-knowledge proving scheme may be as follows:

### Public Input:

| | |
|---|---|
| org_name | Value of variable org_name at line 5 |
| hash_key | Hash of the value of the key variable at line 6 |
| | (input to the private_read function) |
| hash_key_value | Hash of the value assigned to the reputation |
| | variable at line 6 (output of private_read |
| | function) |
| hash_new_reputation | Hash of the value of the new_reputation |
| | variable at line 8 (input to the private_write |
| | function) |
| output_1_name | Name of the variable assigned at line 9 |
| output_1_value | Value assigned to the variable at line 9 |

### Private Input:

| | |
|---|---|
| pvt_key | Value of the key variable at line 6 (input to |
| | the private_read function) |
| pvt_key_value | Value assigned to the reputation variable at |
| | line 6 (output of private_read function) |
| pvt_new_reputation | Value of the new_reputation variable at line 8 |
| | (input to the private_write function) |

FIG. 4 is a diagram illustrating operations of “Smart Contract Execution B,” according to some embodiments. The process may be implemented by peer 110B.

At operation 7-1, peer 110B obtains the smart contract 140, an identifier of the subroutine for which proof of computation is requested, and the proving key. At operation 7-2, peer 110B begins execution of the smart contract 140. At operation 7-3, peer 110B detects the subroutine for which proof of computation is requested. At operation 7-4, peer 110B generates a program adapted for the zero-knowledge proving scheme. This program may be the same program generated by peer 110A at operation 3-4 but independently generated by peer 110B based on the subroutine. In one embodiment, the program adapted for the zero-knowledge proving scheme is generated (and agreed upon by all parties) when the smart contract 140 is installed in the distributed ledger (however, this may not allow for any hardcoded values) instead of being generated by the peers 110, as needed. At operation 7-5, peer 110B executes the subroutine. At operation 7-6, peer 110B generates a zero-knowledge proof of computation of the subroutine based on the program adapted for the zero-knowledge proving scheme, the public input, the private input, and the proving key. At operation 7-7, peer 110B resumes execution of the remainder of the smart contract 140. At operation 7-8, peer 110B generates a full execution result of the smart contract 140.

FIG. 5 is a diagram illustrating operations of “Smart Contract Execution A Part 2,” according to some embodiments. The process may be implemented by peer 110A.

At operation 11-1, peer 110A obtains the smart contract 140, the zero-knowledge proof, the public input, and the partial execution result of the smart contract. At operation 11-2, peer 110A determines whether the zero-knowledge proof is valid. Peer 110A may determine whether the zero-knowledge proof is valid using the zero-knowledge proving scheme (e.g., a “verify” method of the zero-knowledge proving scheme) based on the program adapted for the zero-knowledge proving scheme, the public input, and the verification key. In one embodiment, peer 110A also determines whether the public input is valid. This may involve verifying that the input values for existing variables match the execution state of peer 110A (the execution state of peer 110A just before encountering the subroutine, which may be obtained from the partial execution result), verifying that the input values for the manipulation detection codes of the keys and values for private reads match the public part of the distributed ledger, and/or verifying that the input values for the keys and values of the reads match the distributed ledger. In one embodiment, logic for validating the public input (or at least a portion of it) is coded into the program adapted for the zero-knowledge proving scheme. If peer 110A determines that the zero-knowledge proof (or the public input) is not valid, then the process aborts. Otherwise, if peer 110A determines that the zero-knowledge proof (and the public input) is valid, then at operation 11-3, peer 110A restores the execution state of the smart contract 140 using the partial execution result. At operation 11-4, peer 110A applies the effects of the subroutine, which may involve applying modifications to the execution state of the smart contract (e.g., variable assignments using the output of the subroutine) and pending operations of the distributed ledger (e.g., addition of reads/writes (public/hashed) to reflect the effect of the transaction on the distributed ledger), which information can be obtained from the public input. At operation 11-5, peer 110A resumes execution of the remainder of the smart contract 140. At operation 11-6, peer 110A generates a full execution result of the smart contract 140.

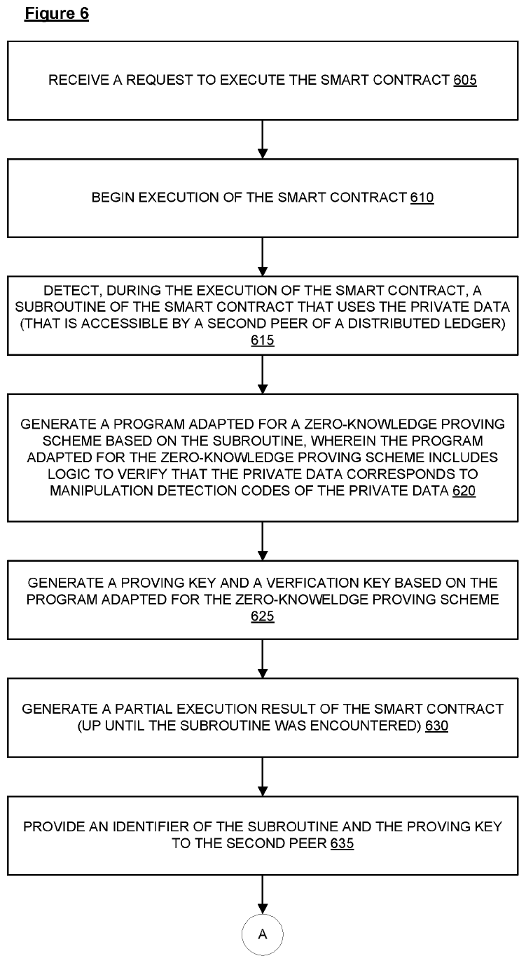

FIG. 6 is a flow diagram of a process for providing trusted execution of a smart contract that uses private data, according to some embodiments. The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams. In one embodiment, the process is implemented by a network device functioning as a first peer of a distributed ledger (e.g., peer 110A) to provide trusted execution of a smart contract that uses private data accessible to a second peer of the distributed ledger but not accessible to the first peer.

At block 605, the first peer receives a request to execute the smart contract.

At block 610, the first peer begins execution of the smart contract.

At block 615, the first peer detects, during the execution of the smart contract, a subroutine of the smart contract that uses the private data (that is accessible by the second peer but not by the first peer). In one embodiment, the subroutine is detected based on metadata included in the smart contract indicating that the subroutine uses the private data.

At block 620, the first peer generates a program adapted for a zero-knowledge proving scheme based on the subroutine, wherein the program adapted for the zero-knowledge proving scheme includes logic to verify that the private data corresponds to manipulation detection codes of the private data. In one embodiment, the zero-knowledge proving scheme is ZK-SNARK and the program adapted for the zero-knowledge proving scheme is an arithmetic circuit.

At block 625, the first peer generates a proving key and a verification key based on the program adapted for the zero-knowledge proving scheme.

At block 630, the first peer generates a partial execution result of the smart contract (up until the point that the subroutine was encountered). In one embodiment, the partial execution result includes a snapshot of a state of a VM executing the smart contract.

At block 635, the first peer provides an identifier of the subroutine and the proving key to the second peer. In one embodiment, the proving key is provided to the second peer via a client component. In one embodiment, the first peer also provides data related to the request to execute the smart contract (e.g., the end-user inputs for the request received at block 605) to the second peer. This may allow the second peer to have access to this data even if a client component that is different from the client component that submitted the smart contract execution request to the first peer is used to submit a smart contract execution request to the second peer.

At block 640, the first peer obtains a zero-knowledge proof of computation of the subroutine and a public input to the program adapted for the zero-knowledge proving scheme, wherein the zero-knowledge proof was generated by the second peer based on the proving key. In one embodiment, the public input includes values of inputs to the subroutine, public data used in the subroutine, the manipulation detection codes of the private data, and an output of the subroutine.

At block 645, the first peer determines whether the zero-knowledge proof is valid using the zero-knowledge proving scheme based on the public input and the verification key.

At block 647, the first peer determines whether the public input is valid.

At decision block 650, if the zero-knowledge proof and/or the public input is not valid, then at block 655 the first peer aborts the process. Otherwise, if both the zero-knowledge proof and the public input are valid, then the process proceeds to block 660.

At block 660, the first peer restores an execution state of the smart contract using the partial execution result.

At block 665, the first peer applies the effects of the subroutine. In one embodiment, the effects of the subroutine are applied based on modifying the execution state of the smart contract and pending operations of the distributed ledger to reflect execution of the subroutine.

At block 670, the first peer resumes the execution of the smart contract after the subroutine to generate a full execution result of the smart contract.

At block 675, the first peer provides the full execution result to a consensus mechanism of the distributed ledger. In one embodiment, the full execution result is provided to the consensus mechanism of the distributed ledger via a client component.

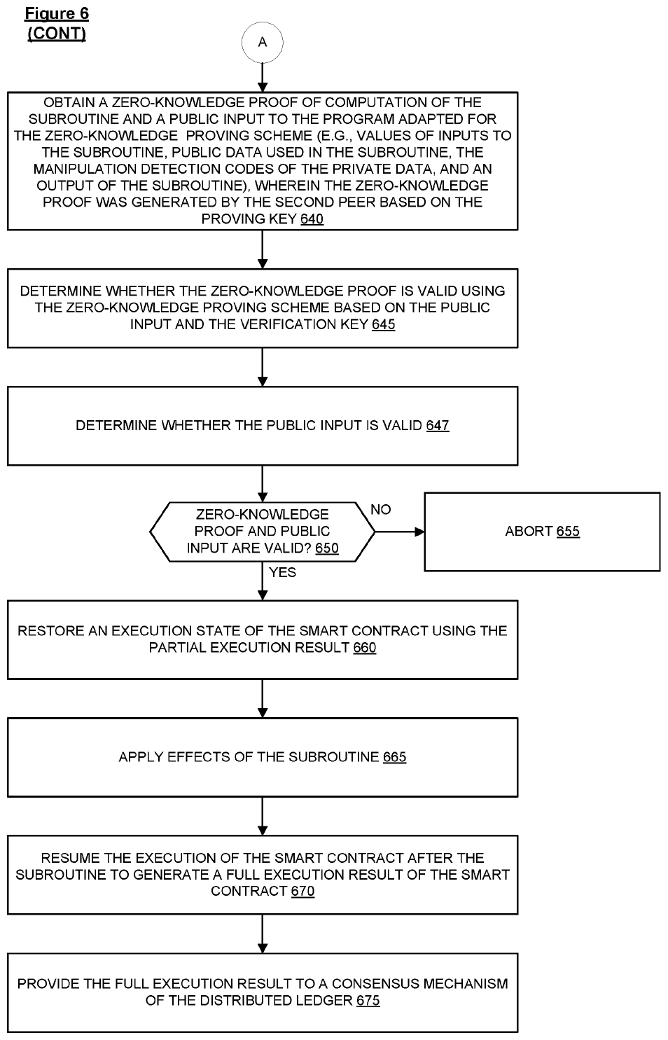

FIG. 7 is a flow diagram of a process for providing trusted execution of a smart contract that uses private data, according to some embodiments. In one embodiment, the process is implemented by a network device functioning as a second peer of a distributed ledger (e.g., peer 110B) to provide trusted execution of a smart contract that uses private data accessible to the second peer but not accessible to a first peer of the distributed ledger.

At block 710, the second peer receives a request to execute the smart contract, a proving key, and an identifier of a subroutine of the smart contract for which proof of computation is requested, wherein the subroutine uses the private data (e.g., that is only accessible by the second peer).

At block 720, the second peer begins execution of the smart contract.

At block 730, the second peer detects, during the execution of the smart contract, the subroutine.

At block 740, the second peer generates a program adapted for a zero-knowledge proving scheme based on the subroutine, wherein the program adapted for the zero-knowledge proving scheme includes logic to verify that the private data corresponds to manipulation detection codes of the private data. In one embodiment, the zero-knowledge proving scheme is ZK-SNARK and the program adapted for the zero-knowledge proving scheme is an arithmetic circuit.

At block 750, the second peer executes the subroutine.

At block 760, the second peer generates a zero-knowledge proof of computation of the subroutine using the zero-knowledge proving scheme based on the program adapted for the zero-knowledge proving scheme, a public input to the program adapted for the zero-knowledge proving scheme, a private input to the program adapted for the zero-knowledge proving scheme, and the proving key. In one embodiment, the public input includes values of inputs to the subroutine, public data used in the subroutine, the manipulation detection codes of the private data, and an output of the subroutine. In one embodiment, the private input includes the private data. In one embodiment, the proving key is generated by the first peer and provided to the second peer via a client component.

At block 770, the second peer resumes the execution of the smart contract after the subroutine to generate a full execution result of the smart contract.

At block 780, the second peer provides, to the first peer, the zero-knowledge proof and the public input. In one embodiment, the zero-knowledge proof (and the public input) is provided to the first peer via a client component.

At block 790, the second peer provides the full execution result to a consensus mechanism of the distributed ledger. In one embodiment, the full execution result is provided to the consensus mechanism of the distributed ledger via a client component.

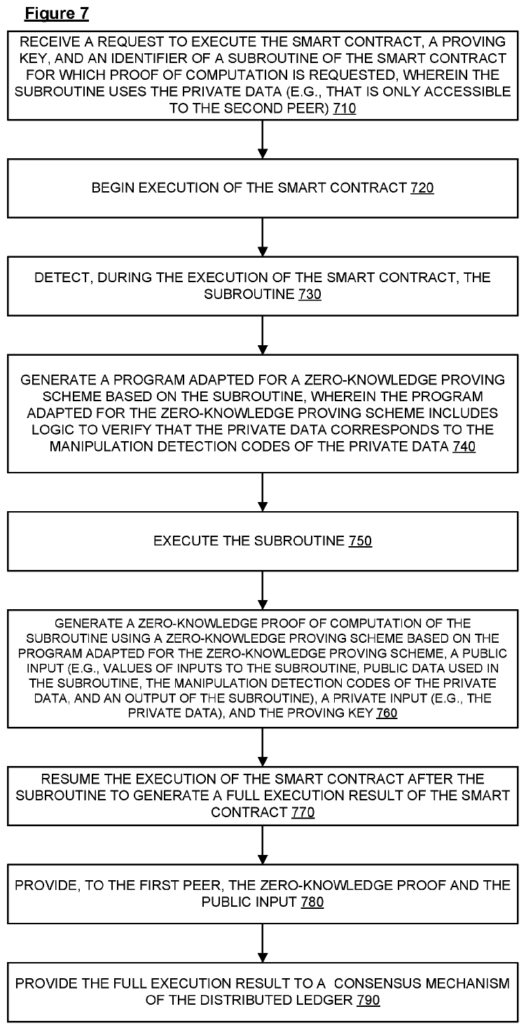

FIG. 8 is a flow diagram of a process for providing trusted execution of a smart contract that uses private data, according to some embodiments. In one embodiment, the process is implemented by a network device functioning as a client component (e.g., client component 120).

At block 810, the client component sends a request to execute a smart contract to a first peer of a distributed ledger (e.g., peer 110A).

At block 820, the client component receives, from the first peer, an identifier of a subroutine of the smart contract for which proof of computation is requested and materials for generating a zero-knowledge proof of computation of the subroutine (e.g., a proving key).

At block 830, the client component determines a second peer of the distributed ledger that has access to private data used in the subroutine.

At block 840, the client component sends, to the second peer, a request to execute the smart contract, the identifier of the subroutine, and the materials for generating the zero-knowledge proof.

At block 850, the client component receives, from the second peer, the zero-knowledge proof and a full execution result of the smart contract, wherein the zero-knowledge proof was generated by the second peer using the zero-knowledge proving scheme based on the materials for generating the zero-knowledge proof.

At block 860, the client component sends, to the first peer, the zero-knowledge proof.

At block 870, the client component receives, from the first peer, a full execution result of the smart contract if the first peer determines that the zero-knowledge proof is valid.

At block 880, the client component provides the full execution results received from the first peer and the second peer to a consensus mechanism of the distributed ledger.

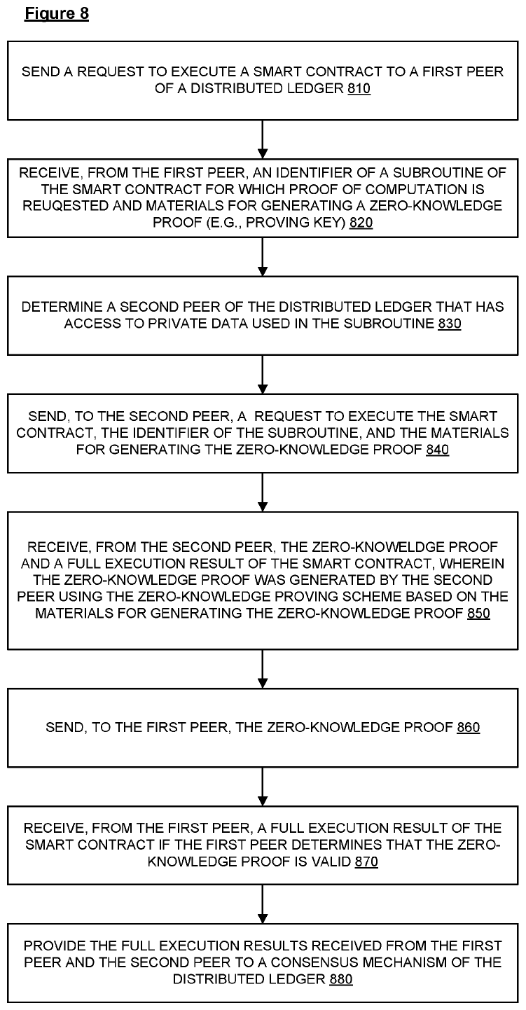

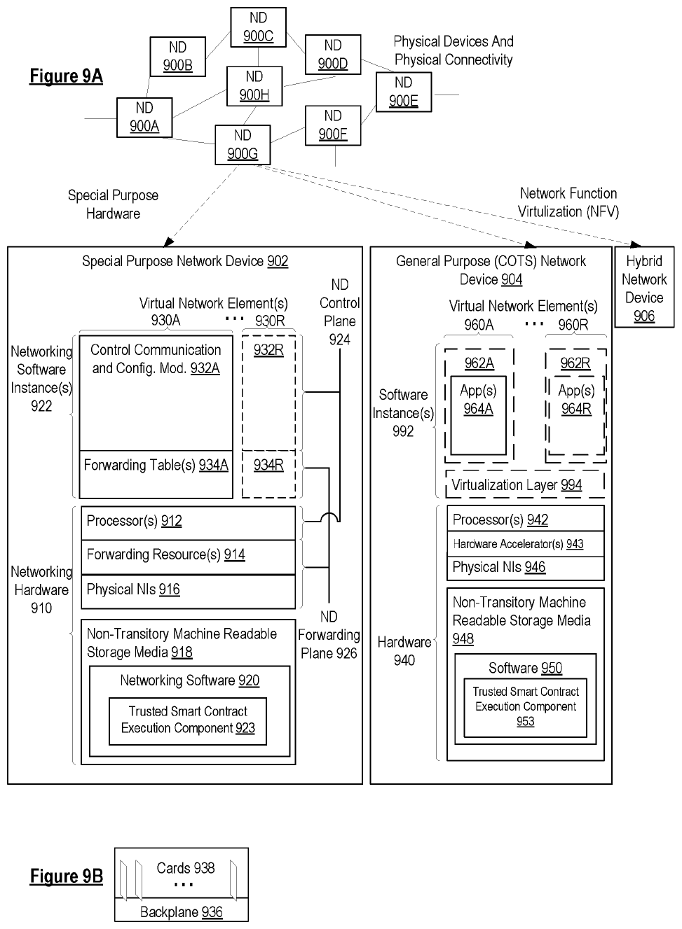

FIG. 9A illustrates connectivity between network devices (NDs) within an exemplary network, as well as three exemplary implementations of the NDs, according to some embodiments of the invention. FIG. 9A shows NDs 900A-H, and their connectivity by way of lines between 900A-900B, 900B-900C, 900C-900D, 900D-900F, 900F-900F, 900F-900G, and 900A-900G, as well as between 900H and each of 900A, 900C, 900D, and 900G. These NDs are physical devices, and the connectivity between these NDs can be wireless or wired (often referred to as a link). An additional line extending from NDs 900A, 900E, and 900F illustrates that these NDs act as ingress and egress points for the network (and thus, these NDs are sometimes referred to as edge NDs, while the other NDs may be called core NDs).

Two of the exemplary ND implementations in FIG. 9A are: 1) a special-purpose network device 902 that uses custom application-specific integrated-circuits (ASICs) and a special-purpose operating system (OS); and 2) a general purpose network device 904 that uses common off-the-shelf (COTS) processors and a standard OS.

The special-purpose network device 902 includes networking hardware 910 comprising a set of one or more processor(s) 912, forwarding resource(s) 914 (which typically include one or more ASICs and/or network processors), and physical network interfaces (NIs) 916 (through which network connections are made, such as those shown by the connectivity between NDs 900A-H), as well as non-transitory machine readable storage media 918 having stored therein networking software 920. During operation, the networking software 920 may be executed by the networking hardware 910 to instantiate a set of one or more networking software instance(s) 922. Each of the networking software instance(s) 922, and that part of the networking hardware 910 that executes that network software instance (be it hardware dedicated to that networking software instance and/or time slices of hardware temporally shared by that networking software instance with others of the networking software instance(s) 922), form a separate virtual network element 930A-R. Each of the virtual network element(s) (VNEs) 930A-R includes a control communication and configuration module 932A-R (sometimes referred to as a local control module or control communication module) and forwarding table(s) 934A-R, such that a given virtual network element (e.g., 930A) includes the control communication and configuration module (e.g., 932A), a set of one or more forwarding table(s) (e.g., 934A), and that portion of the networking hardware 910 that executes the virtual network element (e.g., 930A).

In one embodiment software 920 includes code such as trusted smart contract execution component 923, which when executed by networking hardware 910, causes the special-purpose network device 902 to perform operations of one or more embodiments of the present invention as part of networking software instances 922 (e.g., to provide trusted execution of a smart contract that uses private data).

The special-purpose network device 902 is often physically and/or logically considered to include: 1) a ND control plane 924 (sometimes referred to as a control plane) comprising the processor(s) 912 that execute the control communication and configuration module(s) 932A-R; and 2) a ND forwarding plane 926 (sometimes referred to as a forwarding plane, a data plane, or a media plane) comprising the forwarding resource(s) 914 that utilize the forwarding table(s) 934A-R and the physical NIs 916. By way of example, where the ND is a router (or is implementing routing functionality), the ND control plane 924 (the processor(s) 912 executing the control communication and configuration module(s) 932A-R) is typically responsible for participating in controlling how data (e.g., packets) is to be routed (e.g., the next hop for the data and the outgoing physical NI for that data) and storing that routing information in the forwarding table(s) 934A-R, and the ND forwarding plane 926 is responsible for receiving that data on the physical NIs 916 and forwarding that data out the appropriate ones of the physical NIs 916 based on the forwarding table(s) 934A-R.

FIG. 9B illustrates an exemplary way to implement the special-purpose network device 902 according to some embodiments of the invention. FIG. 9B shows a special-purpose network device including cards 938 (typically hot pluggable). While in some embodiments the cards 938 are of two types (one or more that operate as the ND forwarding plane 926 (sometimes called line cards), and one or more that operate to implement the ND control plane 924 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 936 (e.g., a first full mesh coupling the line cards and a second full mesh coupling all of the cards).

Returning to FIG. 9A, the general purpose network device 904 includes hardware 940 comprising a set of one or more processor(s) 942 (which are often COTS processors) and physical NIs 946, as well as non-transitory machine readable storage media 948 having stored therein software 950. During operation, the processor(s) 942 execute the software 950 to instantiate one or more sets of one or more applications 964A-R. While one embodiment does not implement virtualization, alternative embodiments may use different forms of virtualization. For example, in one such alternative embodiment the virtualization layer 954 represents the kernel of an operating system (or a shim executing on a base operating system) that allows for the creation of multiple instances 962A-R called software containers that may each be used to execute one (or more) of the sets of applications 964A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 954 represents a hypervisor (sometimes referred to as a virtual machine monitor (VMM)) or a hypervisor executing on top of a host operating system, and each of the sets of applications 964A-R is run on top of a guest operating system within an instance 962A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 940, directly on a hypervisor (in which case the unikernel is sometimes described as running within a LibOS virtual machine), or in a software container, embodiments can be implemented fully with unikernels running directly on a hypervisor represented by virtualization layer 954, unikernels running within software containers represented by instances 962A-R, or as a combination of unikernels and the above-described techniques (e.g., unikernels and virtual machines both run directly on a hypervisor, unikernels and sets of applications that are run in different software containers).

The instantiation of the one or more sets of one or more applications 964A-R, as well as virtualization if implemented, are collectively referred to as software instance(s) 952. Each set of applications 964A-R, corresponding virtualization construct (e.g., instance 962A-R) if implemented, and that part of the hardware 940 that executes them (be it hardware dedicated to that execution and/or time slices of hardware temporally shared), forms a separate virtual network element(s) 960A-R.

The virtual network element(s) 960A-R perform similar functionality to the virtual network element(s) 930A-R—e.g., similar to the control communication and configuration module(s) 932A and forwarding table(s) 934A (this virtualization of the hardware 940 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 962A-R corresponding to one VNE 960A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 962A-R to VNEs also apply to embodiments where such a finer level of granularity and/or unikernels are used.

In certain embodiments, the virtualization layer 954 includes a virtual switch that provides similar forwarding services as a physical Ethernet switch. Specifically, this virtual switch forwards traffic between instances 962A-R and the physical NI(s) 946, as well as optionally between the instances 962A-R; in addition, this virtual switch may enforce network isolation between the VNEs 960A-R that by policy are not permitted to communicate with each other (e.g., by honoring virtual local area networks (VLANs)).

In one embodiment, software 950 includes a trusted smart contract execution component 953, which when executed by processor(s) 942, causes the general purpose network device 904 to perform operations of one or more embodiments of the present invention as part of software instances 962A-R (e.g., to provide trusted execution of a smart contract that uses private data).

The third exemplary ND implementation in FIG. 9A is a hybrid network device 906, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 902) could provide for para-virtualization to the networking hardware present in the hybrid network device 906.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 930A-R, VNEs 960A-R, and those in the hybrid network device 906) receives data on the physical NIs (e.g., 916, 946) and forwards that data out the appropriate ones of the physical NIs (e.g., 916, 946). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes, where such an IP address is referred to as the nodal loopback address. The IP address(es) assigned to the NI(s) of a ND are referred to as IP addresses of that ND: at a more granular level, the IP address(es) assigned to NI(s) assigned to a NE/VNE implemented on a ND can be referred to as IP addresses of that NE/VNE.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

In the foregoing specification, embodiments have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. A method by a network device implementing a first peer of a distributed ledger to provide trusted execution of a smart contract that uses private data accessible to a second peer of the distributed ledger but not accessible to the first peer, the method comprising:
receiving a request to execute the smart contract;
beginning execution of the smart contract;
detecting, during the execution of the smart contract, a subroutine of the smart contract that uses the private data;
obtaining a program adapted for a zero-knowledge proving scheme that was generated based on the subroutine, wherein the program adapted for the zero-knowledge proving scheme includes logic to verify that the private data corresponds to manipulation detection codes of the private data;
obtaining a verification key that was generated based on the program adapted for the zero-knowledge proving scheme;
generating a partial execution result of the smart contract;
providing an identifier of the subroutine to the second peer;
obtaining a zero-knowledge proof of computation of the subroutine and a public input to the program adapted for the zero-knowledge proving scheme, wherein the zero-knowledge proof was generated by the second peer based on a proving key that was generated based on the program adapted for the zero-knowledge proving scheme;
determining whether the zero-knowledge proof is valid using the zero-knowledge proving scheme based on the public input and the verification key;
determining whether the public input is valid;
restoring an execution state of the smart contract using the partial execution result in response to a determination that the zero-knowledge proof and the public input are valid;
applying effects of the subroutine;
resuming the execution of the smart contract after the subroutine to generate a full execution result of the smart contract; and
providing the full execution result to a consensus mechanism of the distributed ledger.

2. The method of claim 1, wherein the zero-knowledge proving scheme is zero-knowledge succinct non-interactive argument of knowledge and the program adapted for the zero-knowledge proving scheme is an arithmetic circuit.

3. The method of claim 1, wherein the partial execution result includes a snapshot of a state of a virtual machine executing the smart contract.

4. The method of claim 1, wherein the identifier of the subroutine and the proving key is provided to the second peer via a client component and the full execution result is provided to the consensus mechanism of the distributed ledger via the client component.

5. The method of claim 1, wherein the public input includes values of inputs to the subroutine, public data used in the subroutine, the manipulation detection codes of the private data, and an output of the subroutine.

6. The method of claim 5, wherein the effects of the subroutine are applied based on modifying the execution state of the smart contract and pending operations of the distributed ledger to reflect execution of the subroutine.

7. The method of claim 1, further comprising:
providing data related to the request to execute the smart contract to the second peer.

8. A method by a network device implementing a second peer of a distributed ledger to provide trusted execution of a smart contract that uses private data accessible to the second peer but not accessible to a first peer of the distributed ledger, the method comprising:
receiving a request to execute the smart contract, a proving key, and an identifier of a subroutine of the smart contract for which proof of computation is requested, wherein the subroutine uses the private data;
beginning execution of the smart contract;
detecting, during the execution of the smart contract, the subroutine;
obtaining a program adapted for a zero-knowledge proving scheme that was generated based on the subroutine, wherein the program adapted for the zero-knowledge proving scheme includes logic to verify that the private data corresponds to manipulation detection codes of the private data;
executing the subroutine;
generating a zero-knowledge proof of computation of the subroutine using the zero-knowledge proving scheme based on the program adapted for the zero-knowledge proving scheme, a public input to the program adapted for the zero-knowledge proving scheme, a private input to the program adapted for the zero-knowledge proving scheme, and the proving key;
resuming the execution of the smart contract after the subroutine to generate a full execution result of the smart contract;
providing, to the first peer, the zero-knowledge proof and the public input; and
providing the full execution result to a consensus mechanism of the distributed ledger.

9. The method of claim 8, wherein the zero-knowledge proving scheme is zero-knowledge succinct non-interactive argument of knowledge and the program adapted for the zero-knowledge proving scheme is an arithmetic circuit.

10. The method of claim 8, wherein the public input includes values of inputs to the subroutine, public data used in the subroutine, the manipulation detection codes of the private data, and an output of the subroutine.

11. The method of claim 10, wherein the private input includes the private data.

12. The method of claim 8, wherein the proving key is generated by the first peer and provided to the second peer via a client component, wherein the zero-knowledge proof is provided to the first peer via the client component and the full execution result is provided to the consensus mechanism of the distributed ledger via the client component.

13. A set of non-transitory machine-readable media having computer code stored therein, which when executed by a set of one or more processors of a network device implementing a first peer of a distributed ledger, causes the first peer to perform operations for providing trusted execution of a smart contract that uses private data accessible to a second peer of the distributed ledger but not accessible to the first peer, the operations comprising:
receiving a request to execute the smart contract;
beginning execution of the smart contract;
detecting, during the execution of the smart contract, a subroutine of the smart contract that uses the private data;
obtaining a program adapted for a zero-knowledge proving scheme that was generated based on the subroutine, wherein the program adapted for the zero-knowledge proving scheme includes logic to verify that the private data corresponds to manipulation detection codes of the private data;
obtaining a verification key that was generated based on the program adapted for the zero-knowledge proving scheme;
generating a partial execution result of the smart contract;
providing an identifier of the subroutine to the second peer;
obtaining a zero-knowledge proof of computation of the subroutine and a public input to the program adapted for the zero-knowledge proving scheme, wherein the zero-knowledge proof was generated by the second peer based on a proving key that was generated based on the program adapted for the zero-knowledge proving scheme;
determining whether the zero-knowledge proof is valid using the zero-knowledge proving scheme based on the public input and the verification key;
determining whether the public input is valid;
restoring an execution state of the smart contract using the partial execution result in response to a determination that the zero-knowledge proof and the public input are valid;
applying effects of the subroutine;
resuming the execution of the smart contract after the subroutine to generate a full execution result of the smart contract; and
providing the full execution result to a consensus mechanism of the distributed ledger.

14. The set of non-transitory machine-readable media of claim 13, wherein the zero-knowledge proving scheme is zero-knowledge succinct non-interactive argument of knowledge and the program adapted for the zero-knowledge proving scheme is an arithmetic circuit.

15. The set of non-transitory machine-readable media of claim 13, wherein the public input includes values of inputs to the subroutine, public data used in the subroutine, the manipulation detection codes of the private data, and an output of the subroutine.

16. The set of non-transitory machine-readable media of claim 15, wherein the effects of the subroutine are applied based on modifying the execution state of the smart contract and pending operations of the distributed ledger to reflect execution of the subroutine.

17. A set of non-transitory machine-readable media having computer code stored therein, which when executed by a set of one or more processors of a network device implementing a second peer of a distributed ledger, causes the second peer to perform operations for providing trusted execution of a smart contract that uses private data accessible to the second peer but not accessible to a first peer of the distributed ledger, the operations comprising:
receiving a request to execute the smart contract, a proving key, and an identifier of a subroutine of the smart contract for which proof of computation is requested, wherein the subroutine uses the private data;
beginning execution of the smart contract;
detecting, during the execution of the smart contract, the subroutine;
obtaining a program adapted for a zero-knowledge proving scheme that was generated based on the subroutine, wherein the program adapted for the zero-knowledge proving scheme includes logic to verify that the private data corresponds to manipulation detection codes of the private data;
executing the subroutine;
generating a zero-knowledge proof of computation of the subroutine using the zero-knowledge proving scheme based on the program adapted for the zero-knowledge proving scheme, a public input to the program adapted for the zero-knowledge proving scheme, a private input to the program adapted for the zero-knowledge proving scheme, and the proving key;
resuming the execution of the smart contract after the subroutine to generate a full execution result of the smart contract;
providing, to the first peer, the zero-knowledge proof and the public input; and
providing the full execution result to a consensus mechanism of the distributed ledger.

18. The set of non-transitory machine-readable media of claim 17, wherein the zero-knowledge proving scheme is zero-knowledge succinct non-interactive argument of knowledge and the program adapted for the zero-knowledge proving scheme is an arithmetic circuit.

19. The set of non-transitory machine-readable media of claim 17, wherein the public input includes values of inputs to the subroutine, public data used in the subroutine, the manipulation detection codes of the private data, and an output of the subroutine.

20. The set of non-transitory machine-readable media of claim 17, wherein the private input includes the private data.
